(19) United States
(12) Patent Application Publication
(10) Pub. No.: US 2014/0104291 A1
(43) Pub. Date: Apr. 17, 2014

(54) DATA VISUALIZATION

(71) Applicant: CABLE TELEVISION LABORATORIES, INC., Louisville, CO (US)

(72) Inventor: Gregory D. Rutz, Arvada, CO (US)

(73) Assignee: CABLE TELEVISION LABORATORIES, INC., Louisville, CO (US)

(21) Appl. No.: 13/649,208

(22) Filed: Oct. 11, 2012

(51) Int. Cl. G09G 5/00; G09G 5/02

(52) U.S. Cl. 345/589; 345/619

(57) ABSTRACT

Data visualization is contemplated to facilitate pictorially or otherwise visually representing various types of data, metrics and other information to a viewer. The data visualization may be useful in visually relating multiple sets of data relative to each other in order to visually convey a relationship to the viewer. The data visualization may be useful in visually depicting signal strength or other performance data for a wireless access point relative to a street map or other geographical indicator in order to visually relate wireless signaling performance to spatially distinct areas proximate to the wireless access point.

### TECHNICAL FIELD

The present invention relates to data visualization, such as but not necessarily limited to data visualization sufficient to facilitate visually relating multiple sets of data in order to pictorially convey a corresponding relationship.

### BACKGROUND

Data can be measured, calculated, inferred, estimated and otherwise obtained for virtually anything. The ability to relate various pieces of data can be important to understanding the influence of one piece of data on another, particularly when attempting to diagnosis certain events where the occurrence of the event requires an interpretation of multiple pieces of data. While not necessarily intending to limit the scope and contemplation of the present invention, the processing of data regarding performance of a wireless access point is believed to present one of many examples where difficulties are found in diagnosing performance related issues. A wireless access point is one type of device particularly susceptible to multiple influences on its performance which can be difficult to diagnose due to an external environment having spatially inconsistent obstacles and interferences. This can make it difficult for a network administrator or other monitoring entity, for example, to easily relate performance data associated with performance of a wireless access point to geographical data reflective of a wireless signaling range of the wireless access point.

### BRIEF DESCRIPTION OF THE DRAWINGS

FIG. 1 illustrates a data visualization system as contemplated by one non-limiting aspect of the present invention.

FIG. 2 illustrates a performance message as contemplated by one non-limiting aspect of the present invention.

FIGS. 3a-3e illustrates a color-coded grid as contemplated by one non-limiting aspect of the present invention.

FIGS. 4-6 illustrate a graphical user interface as contemplated by one non-limiting aspect of the present invention.

FIG. 7 illustrates a flowchart of a method for data visualization as contemplated by the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

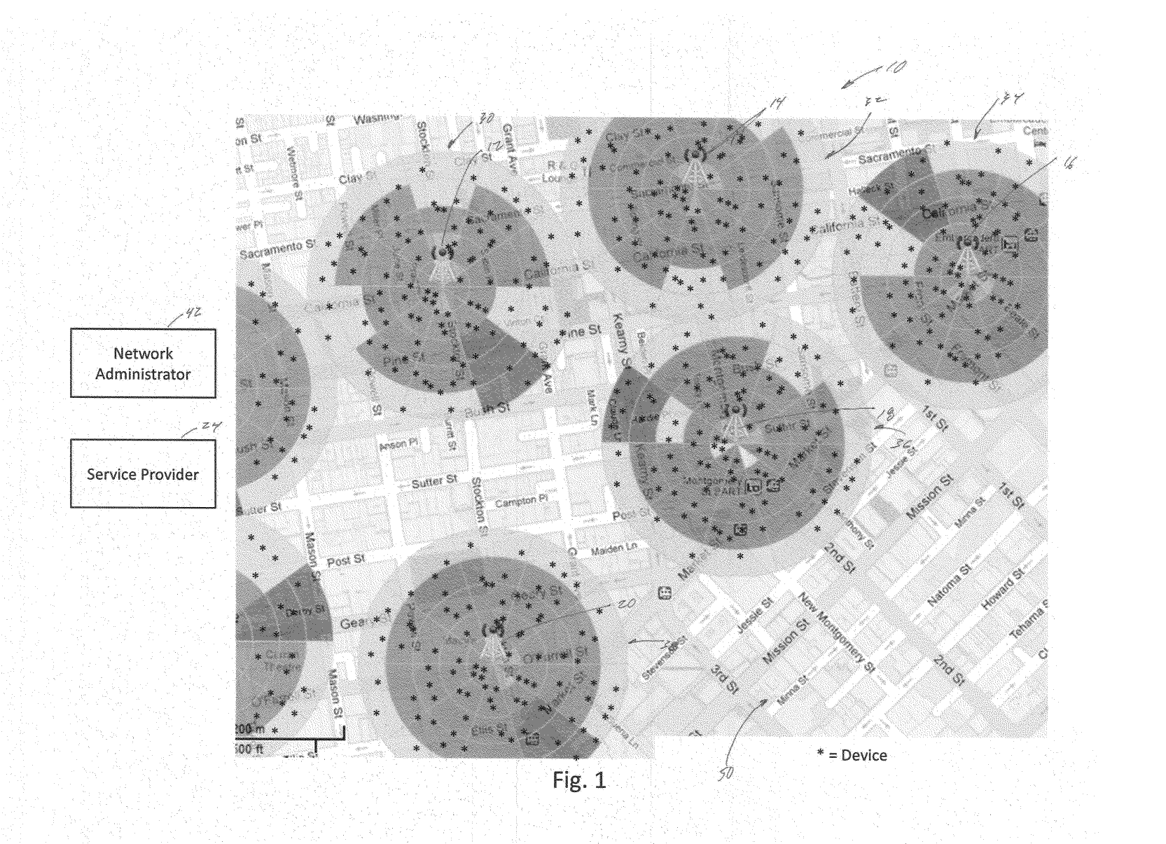

FIG. 1 illustrates a data visualization system 10 as contemplated by one non-limiting aspect of the present invention. The data visualization system 10 is described for exemplary non-limiting purposes with respect to facilitating visual representation of data collected for a plurality of wireless access points 12, 14, 16, 18, 20. This corresponding description is provided without necessarily intending to limit the scope and contemplation of the present invention to visualizing data associated with wireless access points 12, 14, 16, 18, 20 as the present invention fully contemplates its use and application with any type of device, system, network, etc. The description predominately relates to data visualization for wireless access points 12, 14, 16, 18, 20 in order to demonstrate one of the many uses of the present invention to facilitate relating data. The use with wireless access points 12, 14, 16, 18, 20 is one of many environments where a diagnosis of operating capabilities and performance may be difficult to ascertain without visually relating the data in the manner contemplated by the present invention. The wireless access points 12, 14, 16, 18, 20 are described with respect to facilitating Wi-Fi communications, however, the present invention is not necessarily limited to Wi-Fi communications and fully contemplated use and application in any type of wireless communication, including but not limited to cellular, satellite, and any other type of radio frequency (RF) communication.

The wireless access points 12, 14, 16, 18, 20 are shown to be associated with a service provider 24. The service provider 24 may be configured to facilitate relaying signals and other electronic processes necessary to facilitate interfacing signaling between the wireless access points 12, 14, 16, 18, 20 and another network (not shown), such as the Internet. The service provider 24 may be associated with a high-speed data service provider, a multiple system operator (MSO), a cable/satellite/broadcast television service provider, a voice over Internet protocol (VoIP) service provider, a satellite service provider, a cellular service provider, and any other type of service provider which may rely upon wireless signaling to facilitate operations. The wireless access points 12, 14, 16, 18, 20 may be configured to facilitate wireless related signaling and services for any number of wireless devices (labeled “*”). The wireless devices may be required to perform an authentication process with one or more of the wireless access points 12, 14, 16, 18, 20 in order to facilitate signal communications with the service provider 24 or devices connected to other ones of the wireless access points 12, 14, 16, 18, 20. This may require the wireless access points 12, 14, 16, 18, 20 to perform a sign-on operation, zero sign-on operation or some other operation to support Wi-Fi roaming, such as but not limited to the operations associated with U.S. application Ser. No. 12/331,331 and Wi-Fi Roaming Architecture and Interfaces Specification, CableLabs, WR-SP-WIFI-ROAM-102-20216, the disclosures of which are hereby incorporated by reference in their entirety.

The wireless devices may relate to any type of device having capabilities sufficient to facilitate wireless signaling, such as but not necessarily limited to a mobile phone, a computer, a router, a gateway, a set top box (STB), a television, etc. The wireless devices may be configured to facilitate access to virtually any type of wirelessly supportable electronic service. The services accessed through the wireless access points 12, 14, 16, 18, 20 may be dependent on the corresponding service provider 24 and/or subscription rights associated with a user of the wireless device. The wireless devices may include a processor, a memory, and other features (not shown) to facilitate processes required to facilitate connection to one or more of the wireless access points 12, 14, 16, 18, 20 and/or signaling necessary to access the desired services. The wireless devices are shown to be connected to a single one of the wireless access points 12, 14, 16, 18, 20 depending on a wireless signaling range of each wireless access point 12, 14, 16, 18, 20. The wireless signaling range of each access point 12, 14, 16, 18, 20 is spatially represented with a grid 30, 32, 34, 36, 38 used to pictorially describe a range at which the corresponding wireless access point 12, 14, 16, 18, is able to operably support wireless signaling with one or more wireless devices. The wireless access points 12, 14, 16, 18, 20 may be considered to operably support wireless signaling when the signaling is sufficient to support desired communications with one or more of the wireless devices. The wireless access points 12, 14, 16, 18, 20 may be considered to inoperably support wireless signaling with a wireless device in the event the wireless signals are inconsistently received by the wireless device or received a signal power levels less than a desired threshold.

The wireless devices are shown to be connected to a single one of the wireless access points 12, 14, 16, 18, 20 at the same time as it is likely that the wireless devices are limited to supporting signaling with a single wireless access point 12, 14, 16, 18, 20 at one time. The present invention fully contemplates other configurations for the wireless devices, including the capability for the wireless devices to simultaneously support communications with more than one of the wireless access points 12, 14, 16, 18, 20. In the event one of the wireless devices are positioned within a geographical location covered by two or more of the wireless access points 12, 14, 16, 18, 20, the wireless device and/or one of the wireless access points 12, 14, 16, 18, 20 may determine which one of the wireless access points 12, 14, 16, 18, 20 should be used for the wireless services. The active one of the wireless access point 12, 14, 16, 18, 20 may be selected to be the one capable to provide the most reliable or strong signaling with the wireless device and/or the one having the least congestion or the lowest cost to support communications with the wireless device. The wireless device may include capabilities sufficient to facilitate measuring signal strength and assessing and/or collecting data regarding the operating capabilities and/or performance of the wireless access points 12, 14, 16, 18, 20, which can be used to facilitate selecting which one or more of the wireless access points 12, 14, 16, 18, 20 should be connected to for establishing a service connection.

A network administrator 42 may be associated with the service provider 24 and/or one or more of the wireless access points 12, 14, 16, 18, 20 to manage network performance and/or to otherwise facilitate operations with the wireless devices. The network administrator 42 may be configured in accordance with the present invention to collect data regarding operation, performance, metrics and other characteristics of the wireless access points 12, 14, 16, 18, 20 and/or wireless devices in order to facilitate data visualization. One non-limiting aspect of the present invention contemplates the network administrator 42 being configured to facilitate data visualization from the perspective of the wireless devices. The perspective of the wireless devices may be based on wireless signaling and other capabilities being measured from the point of view of the wireless devices. This may require the wireless devices to sense, measure or otherwise generate at least some of the data and/or metrics reflective of wireless signaling performance or other metrics desired for data visualization. Optionally, the wireless access points 12, 14, 16, 18, 20 may be configured to generate data reflective of the wireless signaling without reliance on feedback from the wireless devices, e.g., a broadcast strength of the wireless access point may be monitored to determine the wireless range and/or other operational settings may be reviewed to infer the wireless signaling range and/or capabilities.

The ability to generate data from the perspective of the wireless devices is believed to be more beneficial than simply relying on the wireless access points 12, 14, 16, 18, 20 to generate the data. The reliance on the wireless devices allows the data to be generated from the perspective of the entity receiving the wireless signaling as opposed to entity sourcing the wireless signaling, which can be beneficial in indicating how signals are being consumed versus how they are being delivered or offered for consumption since the consumption can vary significantly from the offer. The wireless devices may be configured to transmit performance messages to the connected wireless access point and/or the network administrator 42 to report data sufficient for use with the contemplated data visualization. The messages may be considered to be performance messages and may be used to report any number of measurable metrics regarding performance of the wireless access point, including but not limited to those associated with wireless signaling or other operations of the wireless access point. These metrics may include: one or more metrics related to the signal itself; signal strength; signal-to-noise ratio; performance of data transmission/reception via the signal, e.g., downstream/upstream data rate; coordinates, geo-location, or other location information regarding a location at which the data was collected; time and date of data collection; and/or information regarding other signals detected.

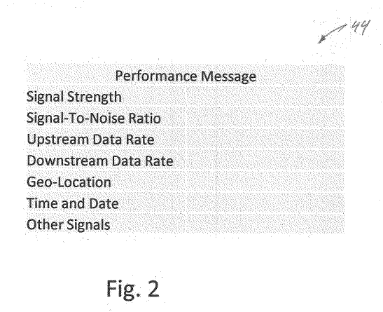

FIG. 2 illustrates a performance message 44 transmitted from one of the wireless devices to report perceived performance. The reported signal strength may be measured according to a Receive Signaling Strength Indicator (RSSI), such as IEEE 802.11 RSSI, which may be measured according to a power ratio in decibels (dB) of the measured power referenced to one milliwatt (mW), e.g., dBm. The signal strength may be proportional to a distance of the wireless device from the wireless access point and/or interferences or objects between the wireless device the wireless access point which may degrade or otherwise reduce signaling power level. The signal-to-noise ratio may be measured to reference the amount of interference present within the wireless signaling. The downstream/upstream data rates may be measured in kilobytes per second (kps) to reflect how quickly data is transmitted between the wireless device and/or the wireless access point, i.e., the bandwidth or capacity of the wireless link between the two devices. The geo-location information may be used to report a specific location at which the wireless device generates the performance message. This geo-location information may be used to identify a particular area within the wireless signaling range of the wireless access point to be associated with the reported data. The geo-location data may be updated with each transmission of the performance message 44 in order to reflect any movement of the wireless device since the last transmission of a performance message. The time and date may be used to indicate a time and data at which information clue with the performance message is relevant. The other signals may be used to indicate other signals being exposed to the wireless device, i.e., identification of other wireless devices having overlapping wireless signal ranges.

Multiple performance messages 44 may be received from any number of wireless devices. The network administrator 42 may be tasked with associating the performance messages with one or more of the wireless access points 12, 14, 16, 18, 20 in order to facilitate the contemplated data visualization. Optionally, a certain number of performance messages 44 may be required in order to generate reliable data for visualization, e.g., multiple wireless devices may be required to submit performance data for each wireless access point 12, 14, 16, 18, 20 and/or for each portion of the wireless signaling area for which data is visualized. FIG. 1 illustrates the contemplated data visualization with various color coding (shading) of the grids 30, 32, 34, 36, 38 displayed for each of the wireless access points 12, 14, 16, 18, 20. The color coding may be used to indicate various performance levels according to a particular one of a plurality of colors. For exemplary non-limiting purposes, three colors (yellow, green, and red) are shown to visualize three different levels of performance. The green color is used to describe a high level of performance, the yellow is shown to describe a middle level of performance, and the red is shown to describe a low level of performance. In this manner, the present invention contemplates displaying or otherwise pictorially describing performance gradients using color coding or other visual values sufficient to convey a special coverage area of the wireless access point relative to any one or more of the metrics noted above or otherwise reported from the wireless access points.

The color-coded grids are shown to be overlaid relative to a street map 50. The street map 50 may be an electronic representation of a geographical area proximate to each of the wireless access points 12, 14, 16, 18, 20. The street map 50 may indicate streets, buildings, businesses, bus stops, and any other information regarding the area proximate to each of the wireless access points 12, 14, 16, 18, 20. The color-coding grids may be scaled to the street map 50 in order to visually indicate an approximate range of the wireless access points 12, 14, 16, 18, 20 relative to components shown within the street map 50. This may provide the viewer an accurate description of distances at which wireless signals are being operably transmitted from the wireless access points 12, 14, 16, 18, 20. The network administrator 42, service provider 24 or other entity may use this visual representation of performance to assess a particular geographical area for wireless performance, e.g., whether the wireless access points 12, 14, 16, 18, 20 are providing sufficient wireless signaling coverage to desired geographical areas. A review of the color-coding grids allows the administrator to visually identify red portions corresponding with low levels of performance, i.e., without having to undertake a cumbersome process of relating numerical representations of performance to geographical coordinates in order to identify particular geographical areas within the wireless signaling range of a wireless access point 12, 14, 16, 18, 20 having signaling difficulties and/or those performing a desired signaling levels.

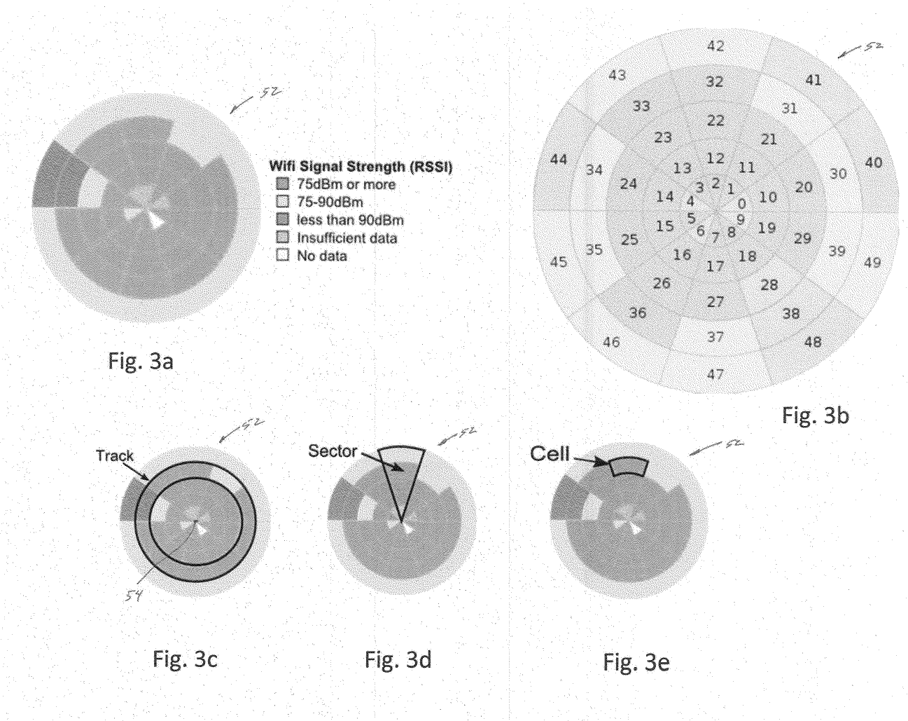

FIGS. 3a-3e illustrate an exemplary color-coded grid 52 used to facilitate the data visualization as contemplated by one non-limiting aspect of the present invention. The color-coated grid 52 may correspond with the color-coding grids 30, 32, 34, 36, 38 illustrated in FIG. 1. The wireless devices reporting performance messages 44 and other values used to generate the color-coded grid 52 have been removed for exemplary purposes. The color-coded grids may segment a wireless signaling range of a wireless access point according to a track, a sector, and a cell. Each of the track, sector, and sell may correspond with a different geographical area of the wireless access point. Each cell is shown to be radially arranged relative to a center portion 54 of the grid corresponding with the wireless access point. This is done for exemplary non-limiting purposes as the cells may be arranged in any other manner. The illustrations provided with the assumption that the wireless access point includes an omnidirectional antenna to facilitate the wireless signaling. The shape and contour of the grid 52 may change depending on the configuration of the antenna and its typical or operational transmission range, i.e., the grid may be being shaped or non-circular depending upon the particular transmission capabilities or restrictions of the antenna or other feature of the wireless access point from which the grid is generated. The size and shape of the cells may be adjusted depending on a desired level of granularity.

FIG. 3b illustrates a numerical value to label each cell for with a numerical value to distinguish it from the other cells. Optionally, the numerical value may be used instead to display data associated with the number of wireless devices operably connected to the wireless access point is the corresponding cell. The numerical values may be visually displayed along with the noted color-coding in order to relate to multiple performance related parameters to the spatial representation of the wireless signaling range, i.e., each one of the cells. The numerical values can be changed to reflect values associated with other ones of the metrics reported in the performance message 44 or otherwise calculated that the network administrator 42, e.g., time taken for wireless devices to log on or be authenticated by the wireless access point for service. The data visually related by the color-coated grid 52 and/or the numerical values may vary depending on particular interest of the network administrator or the reporting capabilities of the wireless devices. Some of the cells are shown to be shaded with a gray color and a white color in order to illustrate insufficient data and no data being associated with one or more of the cells, which can occur if the wireless devices within the cells are unable to report the performance message and/or are unable to measure values consistent with the current display requirements of the grid. Optionally, a minimum number of wireless devices may be required to report data for each cell before a data visualization other than gray or white can be provided for that cell, e.g., at least two wireless devices may be required to report data.

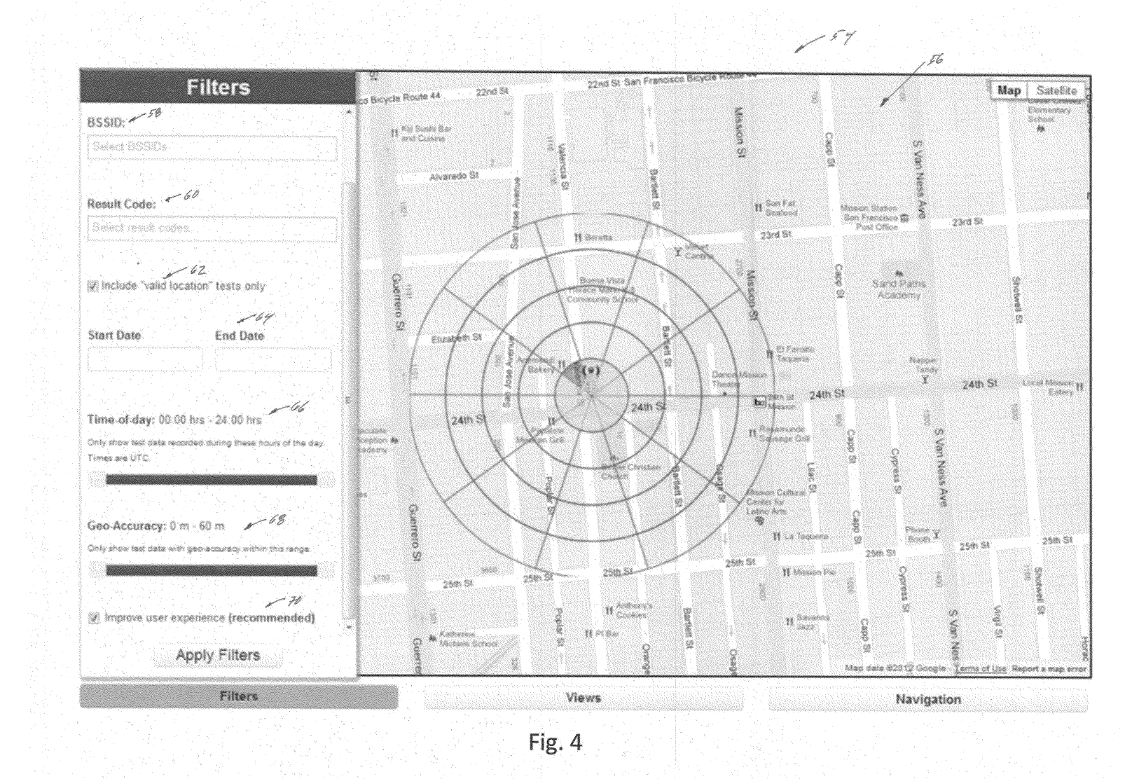

FIG. 4 illustrates a graphical user interface 54 for data visualization as contemplated by one non-limiting aspect of the present invention. The graphical user interface 54 may be output from the network administrator or other entity where a computer-readable medium includes instructions stored therein that are sufficient to operate with a processor to facilitate graphically rendering data. The graphical user interface may be provided through a webpage or other portal to facilitate remote access. The graphical user interface may be used to facilitate displaying data visualizations 56 for any geographical area, which may be beneficial for a service provider tasked with supporting wireless access across a large geographical area. A Basic Service Set Identifier (BSSID) filter 58 may be included to input a service set identifier to call up data visualizations for a particular wireless access point. A result code filter may be included to narrow in on problem test results, i.e., the values which have been found to be below acceptable values. This can be helpful in filtering out some of the failures from valid performances, particularly for a certain geographical area. It can also be used to categorize the errors. A include “valid location” test only box 62 may be included to identify the quality of service as it correlates to a specific geographical location, and since the corresponding testing takes a certain period of time the devices may move, therefore the test may not be valid at all locations of the tested device. A start date and an end date filter 64 may be included to define a period over which data is to be collected for use in generating the color-coated grid or other data visualization. A time of day filter 66 may be included to facilitate selecting a particular time of day within the dates specified in the start date and end date fields for which data is to be display, i.e., a selectable portion of a single day, such as an hour or two, can be displayed rather than displaying performance averaged over the entire day. A geo-accuracy filter 68 may be included to filter how much of the wireless signaling range is display, i.e., a selected one or more of the tracks, sectors, or cells may be displayed rather than displaying each track. An improve user experience box 70 may be included to facilitate optimizing map, such as providing a generic mark instead of a high number of individual devices for the corresponding geographical area, i.e., another view can be automatically selected if it would improve user experience versus the user selected view.

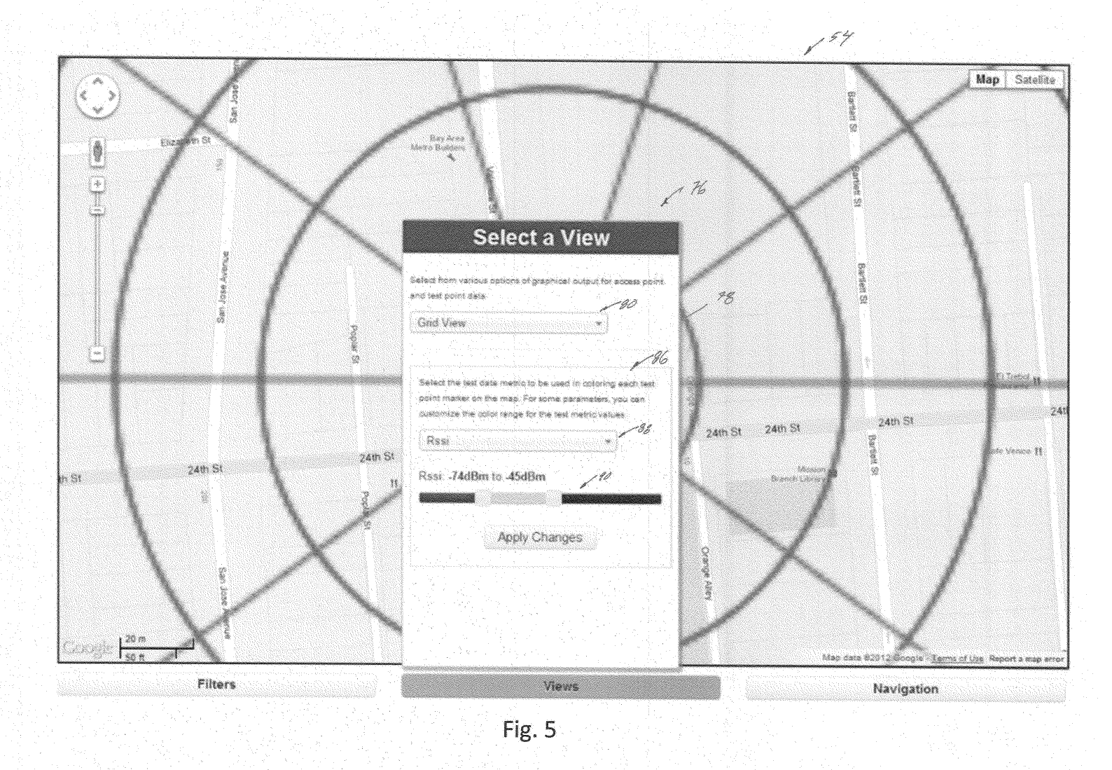

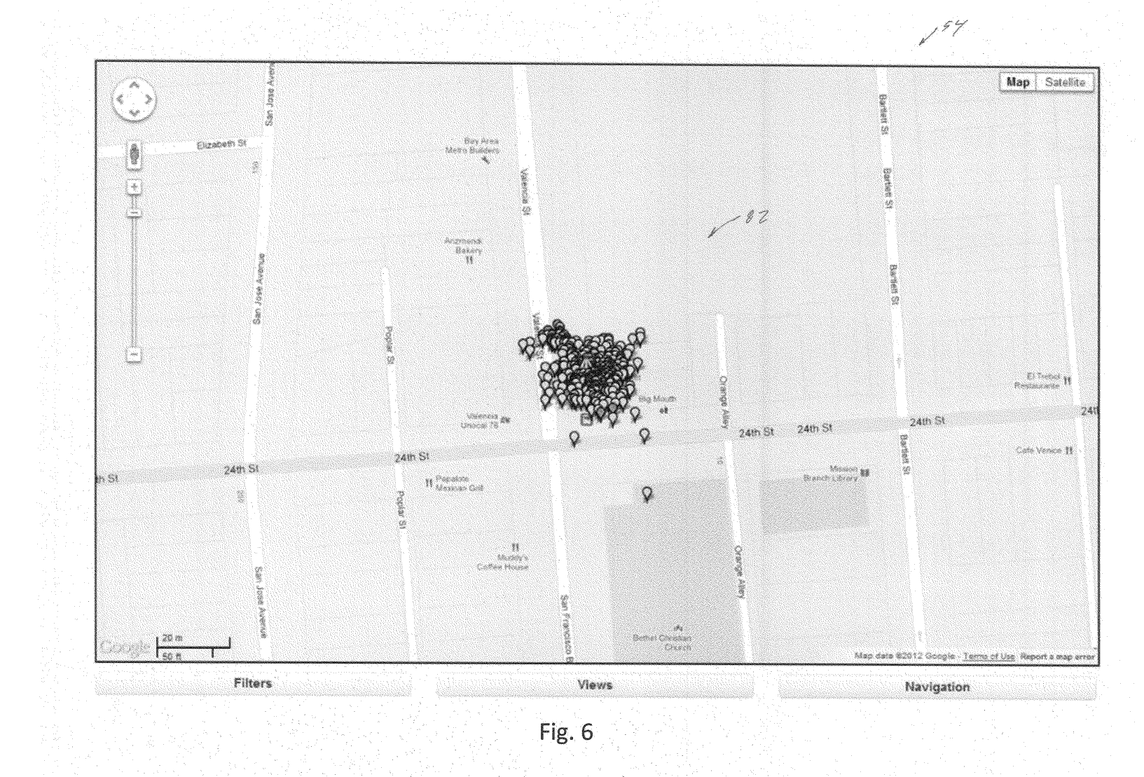

FIG. 5 illustrates a select view input 74 associated with the graphical user interface. The select view input 74 may be selected after selecting the filters in order to change the parameters being visually reported. A select view window 78 may be presented with a grid view drop-down menu 80. The drop-down menu 80 may be selected to illustrate a grid view of the desired wireless access point (e.g., the grids shown within FIGS. 3a-3e are examples of a grid view) or to select other displayable options, such as a points of view. FIG. 6 illustrates a point view display 82 as contemplated by one non-limiting aspect of the present invention. The point of view 82 may be selected from menu 80 to illustrate a color-coded representation of each individual wireless access point having data associated with the filters set in FIG. 4. The points view visually displays data reported from the wireless access point with similar color coding but without depicting a wireless signaling range of the wireless access point. Returning to FIG. 5, a data selection menu 86 may include a metric drop-down menu 88 and a threshold input 90. The drop-down menu 88 may be used to select one or more of the metrics to be displayed within the color-coated grid. The threshold input 90 may be used to select thresholds for the color-coding or other numerical or non-numerical coding displayed within the visual output. For exemplary non-limiting purposes, the metric menu shown to correspond with a signal strength metric and the threshold input is shown to correspond with selecting three colors relative to two threshold values, e.g., −74 dBm and −45 dBm.

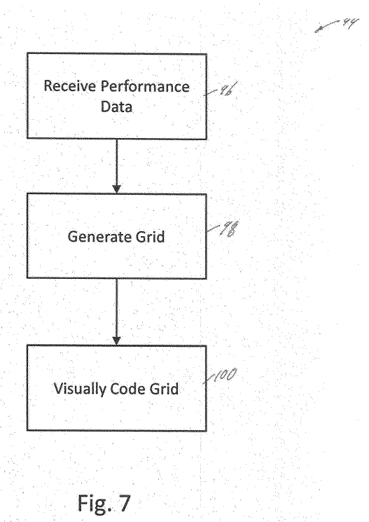

FIG. 7 illustrates a flowchart 94 of a method for data visualization as contemplated by the present invention. The method may be sufficient to facilitate the data visualization described above. Block 96 relates to receiving performance data. The performance data may relate to metrics and other data reported regarding the performance of a certain wireless access point and devices it wirelessly services. Optionally, the performance data may be generated from the perspective of the wireless devices, i.e., based on measurements and other operations sense to process at the wireless device. While the present invention is predominately described with respect to the wireless access points, the method contemplated by the present invention is not necessary limited to facilitating data visualization for a wireless access point as it may be applied to data visualization for virtually any type of system. Block 98 relates to generating a grid or other visual indicator sufficient to spatially relate the data collected in block 96 to the wireless access point. Optionally, rather than generating a grid to spatially relate the data, other shapes or illustrations may be used that are not dependent on a special relationship. Block 100 relates to visually coding the grid to convey performance gradients or other differentiations within the wireless signaling range of the access point. Optionally, rather than color coding cells were particular areas of the grid, the visual coding may include numerical values or other representations depending on the particular configuration of the grid.

As supported above, one non-limiting aspect of the present invention relates to visualizing positional data corresponding to a central signal source where the 360° region around the source is subdivided into “cells”. Each cell is assigned a color based on collected data points that within it. Optionally, in order to analyze the quality or characteristics of a signal that originates from a particular source, it may be desirable to collect multiple data points at various positions within the signal's geographic coverage area. Once the points have been collected, the data within a particular sub-region of the coverage area may be aggregated and analyzed to produce a more generalized view of the data that is easier for an analyst to process. This may include rendering of a graphical display centered on the signal source location that provides generalized information pertaining to the signal as perceived by devices that receive it. The rendering may be a circular grid divided into “sectors” and “tracks”. The number of sectors and tracks is configurable to provide more or less geographical granularity in aggregating the collected data. The resulting regions of the grid are referred to as “cells”.

The size of the circular grid may be assigned a radius in units of linear measurement (feet, meters, miles, etc.). The radius of the grid may be determined using a constant theoretical range of the signal source or by using the distance of the furthest collected point from the signal source. Each cell in the grid may be given a number. Each collected data point may be assigned to a cell number based on the location of the receiving device at the time the data was collected relative to the signal source (the circle center) Each cell may be assigned a color value based on an operator-specific computation applied to the data points located within the bounds of that cell. It may be useful to project the image over a map or some other geographical rendering of the signal source's location. The grid image may be generated with a configurable amount of transparency so as to be able to see features represented in the image beneath it. The image can be generated with an accompanying legend to indicate the underlying meaning of each color as rendered in the grid, such as to provide geographic-based analysis of the signals emanating from the signal source. To provide the highest quality of service in delivery of the signal, the operator can use the method to diagnose potential sources of congestion, interference, or obstruction within the geographic coverage area of the signal. By dividing the coverage are into sub-regions, the method allows the operator to further constrain its search for the root cause of any problem

In addition to visualizing data from a single signal source, this method may be used in analyzing the geographic coverage of multiple signal sources relative to each other along with potential negative (or positive) interactions of signals. An operator can use this invention to quickly diagnose problems with their signal deployments. The quicker the operator can diagnose the problem associated with a particular signal source, the quicker the problem can be resolved. This leads to higher customer satisfaction with the service. This methodology contemplates providing information regarding the signal as perceived by the receiving device from potentially multiple signal sources. In the areas where signals from multiple sources are overlapping, it is more difficult to diagnose problems originating from a particular source, particularly form the perspective of the wireless device unless the wireless devices are used to report the data and the wireless access point on which it is based. The invention may provide visualization of signal metrics relating to a particular signal source. In a situation where multiple signal sources have overlapping coverage due to a need to relieve congestion, it provides immediate feedback regarding whether each signal source is operative at is optimum potential.

One non-limiting aspect of the present invention contemplates the network administrator or other entity providing a client or application to the wireless device to facilitate report the data for visualization. The client may be capable of download and run on a phone for example in a manner that has value to the subscribers in order to insure a subscriber runs the app, otherwise the MSO may have no data points to use for its network service analysis. The client app may automatically connect the user's device to an MSO Wi-Fi access point (perform credential authentication, etc.)—and leave them connected. The data collection portion of the app may occur during this connection process. If the app can not find an MSO access point, it may be able to guide them to the nearest one. The app may be able to show the user a map of all the access points anywhere in the city (or state, or country). For example, so they can plan for an upcoming business trip. The app could detect low RSSI and attempt to perform a “handoff” to another. The app should be able to tell if there is an adjoining access point and attempt to get them connected (the user will see a short disconnect in service, but this is better than what they have today). As opposed to being a “WifiCheck” app, the client may be a “WifiConnection” app. To the user, it may be something that allows them to connect to the MSO Wi-Fi network without having to search for the AP and do a manual connect. For the MSO, it may be a data collection tool to help them troubleshoot their network.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of data visualization comprising:
receiving performance data representing performance of a wireless access point in wirelessly servicing a plurality of wireless devices, the data representing performance from a perspective of the plurality of wireless devices;
generating a grid to represent a wireless service area of the wireless access point, the grid spatially representing distances at which the wireless devices operably receive wireless signaling from the wireless access point; and
visually segmenting the grid to depict performance gradients within the wireless service area, the performance gradients being determined according to the performance data to represent performance of the wireless access point from the perspective of the wireless devices.

2. The method of claim 1 further comprising segmenting the grid into a plurality of cells and visually coding each of the cells to represent distinguishable levels of performance.

3. The method of claim 2 further comprising visually coding each cell with at least one of a plurality of colors, each color representing a different level of performance.

4. The method of claim 3 further comprising visually coding each cell with one of a first color, a second color and a third color, the first color representing signal strength within a first range, the second color representing signal strength within a second range, and the third signal representing signal strength within a third range, each of the first, second and third ranges being different.

5. The method of claim 4 further comprising determining signal strength within each cell to be within one of the first, second and third ranges based on an average signal strength of wireless signals detected by wireless devices within the corresponding cell, the wireless signals being transmitted from the access point and the signal strength being measured by the wireless devices.

6. The method of claim 2 further comprising visually coding each cell with at least one numerical value, each numerical value representing a different level of performance.

7. The method of claim 2 further comprising determining user input of a plurality of performance ranges, the performance ranges defining an upper boundary and a lower boundary for the levels of performance.

8. The method of claim 2 further comprising receiving the performance data by way of performance messages transmitted from the wireless devices, the performance messages being independently generated by each wireless device according to perceive performance.

9. The method of claim 8 wherein each performance messages consists of at least one of signal strength metric, a signal-to-noise ratio metric, a downstream data rate metric and an upstream data rate metric.

10. The method of claim 9 wherein each performance messages identifies at least one of a location, a time and a date at which the least one of signal strength metric, the signal-to-noise ratio metric, the downstream data rate metric and the upstream data rate metric was perceived.

11. A computer-readable medium having instructions stored therein that when operated with a processor facilitate graphically rendering performance data for a wireless service area, the wireless service area being associated with a wireless access point configured to wirelessly service a plurality of wireless devices, the computer-readable medium comprising instructions sufficient for:
relating performance data perceived by the wireless devices to spatially distinct portions of the wireless service area; and
graphically rendering performance representations visually indicative of performance levels for the spatially distinct portions of the wireless service area.

12. The computer-readable medium of claim 11 further comprising instructions sufficient for rendering the performance representations in a pattern spatially shaped to approximate the wireless service area, the pattern visually indicating a direction and a distance at which wireless signals emanating from the wireless access point are operably received at one or more of the wireless devices.

13. The computer-readable medium of claim 12 further comprising instructions sufficient for representing signaling strength of the wireless signals emanating from the wireless access point as perceived by the wireless devices such that the pattern of performance representations visually indicates signaling strength for different portions of the wireless signaling area.

14. The computer-readable medium of claim 11 further comprising instructions sufficient for rendering the performance representations as a plurality of cells radially centered at the wireless access point, each cell including at least one performance representation indicative of at least one performance level within the corresponding portion of the wireless service area.

15. The computer-readable medium of claim 14 further comprising instructions sufficient for rendering the performance representations by shading each one of the cells with one of a plurality of colors, each color representing a different level of performance.

16. The computer-readable medium of claim 15 further comprising instructions sufficient for overlaying the pattern of performance representations relative to a street map, the street map illustrating streets, buildings, and/or other objects located in a vicinity of the access point.

17. A method of visually indicating wireless signaling strength for a plurality of wireless access points configured to broadcast wireless signals from an omnidirectional antenna, the wireless signaling strength representing signal strength of the wireless signals perceived by a plurality of wireless devices, the wireless devices being within a wireless signaling range of one or more of the wireless access points, the method comprising:
processing signal strength data transmitted from the plurality of wireless devices, the signal strength data indicating signal strength of the wireless signals perceived by the wireless devices;
generating a grid for each of the wireless access points based on the signal strength data, each grid spatially approximating a signaling pattern of the corresponding wireless access point, the grid comprising a plurality of cells radially centered at the corresponding wireless access point, each cell spatially representing a portion of the wireless signaling range of the corresponding wireless access point; and
color coding the cells with a color reflective of an average signaling strength within the corresponding cell, the average signaling strength being determined from signal strength data generated from wireless devices while receiving wireless signal within the corresponding cell.

18. The method of claim 17 further comprising overlaying the grid generated for each wireless access point over a street map, the overlaid grids being scaled relative to the street map to pictorially illustrate signal strength relative to illustrations of streets, buildings and/or other objects in a vicinity of the wireless access points.

19. The method of claim 17 further comprising color coding at least a first portion of the cells having the average signal strength less than a first threshold with a first color and color coding at least a second portion of the cells having the average signal strength greater than the first threshold with a second color, the second color being visually distinct from the first color.

20. The method of claim 17 further comprising determining the average signaling strength for at least a majority of the cells from signal strength data transmitted from at least two or more wireless devices authenticated by a service provider of the corresponding wireless access point to receive wireless services.
